(19) United States
(12) Patent Application Publication
(10) Pub. No.: US 2020/0263355 A1
(43) Pub. Date: Aug. 20, 2020

(54) A SHEATH OF A STRUCTURAL CABLE COMPRISING HEATING COMPONENTS

(71) Applicant: SOLETANCHE FREYSSINET, Rueil Malmaison (FR)

(72) Inventors: Julien ERDOGAN, Colombes (FR); Emmanuel CROS, Paris (FR); Nicolas FABRY, Antony (FR); Riad SARRAF, Querqueville (FR)

(21) Appl. No.: 16/652,008

(22) PCT Filed: Sep. 29, 2017
(86) PCT No.: PCT/IB2017/001357

§ 371 Date: Mar. 27, 2020

(51) Int. Cl. D07B 1/14; D07B 1/16; E01D 19/16; H05B 3/56

(52) U.S. Cl. CPC D07B 1/147; D07B 1/162; E01D 19/16; D07B 2501/203; D07B 2201/2086; D07B 2201/2087; D07B 2401/203; H05B 3/56

(57) ABSTRACT

A sheath of a structural cable of a construction work, the structural cable being destined to comprise a bundle of tendons (20) destined to bear a load of the structural cable and to be received within said sheath, the sheath having an outer surface (30) and the sheath being made of a single layer of material (32) over at least a part of the length of the sheath.

The sheath comprises heating components (34) arranged within said single layer (32), the heating components (34) being configured for receiving electrical energy and, using said electrical energy, heating at least the outer surface (30) of the sheath so as to prevent ice, snow, rime or frost from forming thereon or remove ice, snow, rime or frost from the outer surface (30) of the sheath.

This application is a National Stage Application of International Application No. PCT/IB2017/001357, filed on Sep. 29, 2017, which is hereby incorporated by reference in its entirety for all purposes as if fully set forth herein.

The present invention relates to structural cables used in civil engineering, for instance in cable-stayed bridges. It is applicable, in particular, to the sheath of such cables used for supporting, stiffening or stabilizing structures.

### BACKGROUND

Stay cables are widely used to support suspended structures such as bridge decks or roofs. They can also be used to stabilize erected structures such as towers or masts.

A typical stay cable includes a bundle of tendons, for example wires or strands, housed in a collective sheath. The sheath is intended to protect the metallic tendons of the bundle.

By design, the sheath is destined to be in contact with the surrounding environment. As such, it is susceptible to the formation of frost, rime, ice or snow thereon.

Addressing this phenomenon is important, as the presence of frost, rime, ice or snow on the sheath may significantly alter the aerodynamic properties of the stay cable, which in turn may lead to vibrations of the cable.

Several approaches have been developed to address this specific problem, such as an approach relying on a metallic collar configured to break ice and frost by being moved along the sheath.

However, this is not fully satisfactory, as it tends to erode the sheath, and plainly become unusable in certain circumstances.

In addition, the other known approaches all exhibit drawbacks.

An object of the present invention is to propose a sheath of a structural cable that can prevent ice, frost, rime or snow from forming thereon and/or remove ice, frost, rime or snow therefrom in an improved manner.

### SUMMARY

To that end, the invention relates to a sheath of a structural cable of a construction work, the structural cable being destined to comprise a bundle of tendons destined to bear a load of the structural cable and to be received within said sheath, the sheath having an outer surface and the sheath being made of a single layer of material over at least a part of the length of the sheath, the sheath comprising heating components arranged within said single layer, the heating components being configured for receiving electrical energy and, using said electrical energy, heating at least the outer surface of the sheath so as to prevent ice, snow, rime or frost from forming thereon or remove ice, snow, rime or frost from the outer surface of the sheath.

According to an aspect of the invention, the heating components are located within a portion of the single layer having a thickness inferior to 30% of the thickness of said single layer.

According to an aspect of the invention, the portion includes the outer surface of the sheath.

According to an aspect of the invention, the portion is at a distance from the outer surface of the sheath.

According to an aspect of the invention, the portion is at a distance from the outer surface inferior or equal to 20% of the thickness of the single layer.

According to an aspect of the invention, the heating components are dispersed within the entirety of said single layer.

According to an aspect of the invention, the heating components include silver or carbon nanoparticles.

According to an aspect of the invention, the heating components include one or more electrical wires.

According to an aspect of the invention, the heating components are arranged so as to define at least one heating sheet within the sheath.

According to an aspect of the invention, the sheet is an openwork sheet.

According to an aspect of the invention, the porosity rate of the openwork sheet is at least 50%, wherein the porosity rate represents the ratio between the open surface of the sheet and the total surface of the sheet.

The invention also relates to a structural cable comprising:
a bundle of tendons which bear a load of said structural cable, and
a sheath as defined above, said sheath receiving the bundle of tendons therein.

According to an aspect of the invention, the structural cable further comprises a source of energy configured to provide the heating components with electrical energy to heat at least the outer surface of the sheath.

The invention also relates to a method of manufacturing a sheath of a structural cable of a construction work, the structural cable being destined to comprise a bundle of tendons destined to bear a load of the structural cable and to be received within said sheath, the sheath having an outer surface and the sheath being made of a single layer of material over at least a part of the length of the sheath, the method comprising forming the sheath from said material, wherein heating components are arranged within said material, the heating components being configured for receiving electrical energy and, using said electrical energy, heating at least the outer surface of the sheath so as to prevent ice, snow, rime or frost from forming thereon or remove ice, snow, rime or frost from the outer surface of the sheath.

### BRIEF DESCRIPTION OF THE DRAWINGS

Other features and advantages of the invention disclosed herein will become apparent from the following description of non-limiting embodiments, with reference to the appended drawings, in which:

FIG. 1 illustrates a structural cable according to the invention;

FIG. 2 illustrates the structure of the cable of FIG. 1;

FIG. 3a illustrates a radial-section of an example of the sheath and cable according to the invention;

FIG. 3b illustrates a cross-section of the sheath of FIG. 3a;

FIG. 3c illustrates a cross-section of an example of the sheath according to the invention;

FIG. 4a illustrates a radial-section of another example of the sheath according to the invention;

FIG. 4b illustrates a cross-section of the sheath of FIG. 4a;

FIG. 4c illustrates a section along the plan illustrated in FIG. 4a exhibiting wires arranged within the sheath of FIG. 4a;

FIG. 5a illustrates a radial-section of another example of the sheath according to the invention;

FIG. 5b illustrates a cross-section of the sheath of FIG. 5a;

FIG. 6a illustrates an example of method of manufacturing the sheath according to the invention;

FIG. 6b illustrates another example of method of manufacturing the sheath according to the invention; and

### DESCRIPTION OF EMBODIMENTS

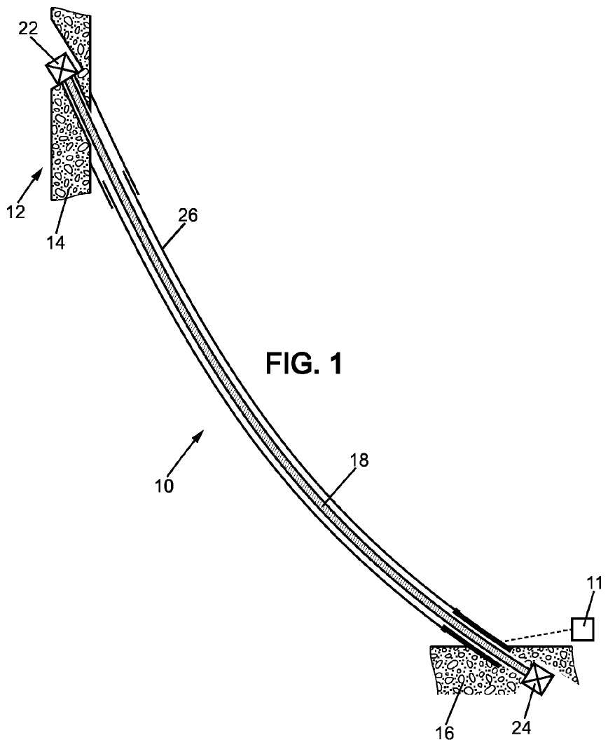

FIG. 1 shows a structural cable 10 according to the invention, hereinafter cable 10. The cable 10 is preferentially a stay or a suspension cable.

The cable 10 is configured to take up efforts applied to a structure 12 to which it is anchored. To that end, it extends between two parts 14, 16 of a construction work which includes the structure 12. The first part 14 is for instance at a higher position than the second part 16. For example, the first part 14 belongs to the structure 12, such as a tower, while the second part 16 belongs to a foundation to stabilize the structure. Alternatively, the first part 14 may belong to a pylon, while the second part 16 belongs to some structure suspended from the pylon.

The construction work typically includes a number of structural cables 10, only one of them being shown in FIG. 1.

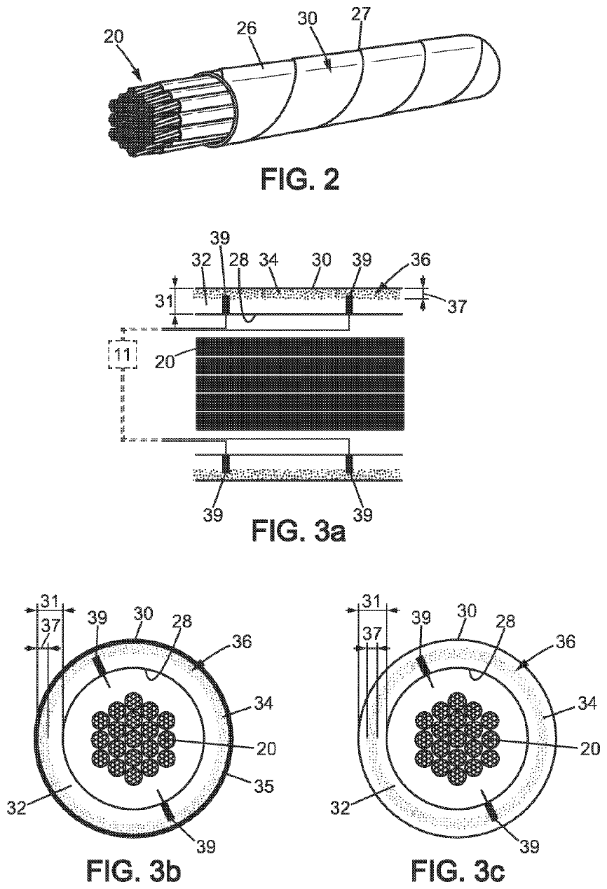

The structural cable 10 comprises a load-bearing part 18 which comprises a bundle of tendons 20 disposed parallel to each other (FIG. 2). For example, the bundled tendons may be strands of the same type as used to pre-stress concrete structures. They are for instance made of steel. Each strand may optionally be protected by a substance such as grease or wax and/or individually contained in a respective plastic sheath.

The bundle 20 forms the structural core of the cable 10, i.e. a main load-bearing component of the cable.

The cable 10 may have a length of up to several hundred meters. The bundle 20 may include a few tens of tendons.

The tendons of the bundle 20 are anchored at both ends of the bundle using an upper anchoring device 22 mounted on the first part 14 of the construction work and a lower anchoring device 24 mounted on the second part 16 of the construction work. Between the two anchoring devices 22, 24, the bundle of tendons for instance follows a catenary curve due to the weight of the cable and the tensile force maintained by the anchoring devices. The anchoring devices 22, 24 are positioned on the first and second parts 14, 16 by taking into account the pre-calculated catenary curve of each cable 10.

In reference to FIG. 2, in addition to the load-bearing part 18, the cable 10 includes a sheath 26 within which the bundle 20 is received. The sheath forms a collective sheath for the bundle 20.

The sheath 26 forms a protective structure for the bundle 20. More precisely, it presents itself in the general form of a tube which internally defines a cavity running along the length of the cable and within which the bundle of tendons is arranged.

The sheath 26 is in particular configured to protect the tendons from the surrounding environment, which would otherwise degrade the tendons rapidly.

In practice, it protects the tendons against mechanical and climatic stresses, such as air, light (in particular UV rays), humidity, rain, frost, snow, that may be combined with wind and/or chemical stresses due to air pollution and so on.

Advantageously, the sheath 26 extends over more than 80% of the length of the bundle of tendons 20 between the anchoring devices 22, 24, or even more than 90% for long stay cables.

In the example illustrated in FIG. 1, the first end of the sheath 26 bears on a guide tube through which the bundle of tendons passes near the lower anchoring device 24, while the second end of the sheath 26 penetrates into another tube disposed on the first part 14 of the construction work, through which the upper end of the bundle of tendons passes to reach the upper anchoring device 22.

The sheath 26 has a cross-section which has any known shape.

For instance, this shape is chosen among polygonal, elliptical or circular. Advantageously, as shown on the Figures, this cross-section is circular.

The shape of the cross-section may vary along the longitudinal direction of the cable. Preferably however, it does not.

In addition, as depicted in FIG. 1, the cable 10 comprises a source of energy 11. As discussed below in more details, in the context of the invention, the source of energy 11 is configured to provide heating components 34 arranged within the sheath 26 with electrical energy so that these components heat at least the outer surface 30 of the sheath 26 and thereby prevent the formation and/or cause the removal of ice, frost, rime, snow from the sheath.

The sheath itself is illustrated in more details in reference to FIGS. 3a to 5b. It should be noted that the scale of the components of the cable depicted in these Figures is not necessarily respected so as to better illustrate the various elements of the cable.

The sheath 26 has an inner surface 28 and an outer surface 30.

The inner surface 28 faces the bundle of tendons.

The outer surface 30 is opposite to the inner surface 28. The outer surface 30 faces outwardly relative to the cable. It is for instance destined to be in direct contact with the surrounding environment and protect the bundle of tendons from it. In alternative configurations, it is destined to be at least in part in contact with another structure, such as a coating of the cable.

To that end, the outer surface 30 advantageously presents a surface treatment and/or structure destined to increase its resistance to the combined effects of rain and wind. For instance, the outer surface 30 of the sheath 26 may present at least one helical rib 27, and advantageously a double helical rib (not shown), running helically along all or part of the length of the outer surface of the sheath 26.

It should be noted that the outer surface of the sheath advantageously has a color which is designed to absorb solar radiations so as to thereby heat the outer portion of the thickness and prevent snow, ice, rime and frost to form thereon. For instance, the outer surface therefore exhibits a black color. It should be noted that in such a scenario, the matter of the outer surface is nonetheless resistant to UV radiations.

The sheath 26 may be an integral member between its longitudinal extremities. Alternatively, the sheath 26 includes longitudinal segments which are assembled together in an aligned manner, for instance through any known process. For instance, each segment has a length of a few meters, for instance between 6 and 12 m.

Each segment may present itself in the form of an integral piece of tube. Alternatively, one or more segment includes a plurality of sector-shaped elements assembled together.

Advantageously, the thickness 31 of the sheath 26, which corresponds to the radial distance between the inner surface 28 and the outer surface 30, is constant around the axis of the cable. Advantageously, this thickness 31 is comprised between 3 mm and 50 mm, and preferably between 5 mm and 30 mm.

In the context of the invention, at least over part of the length of the sheath 26, the sheath 26 comprises a single integral layer 32 of material which is adapted to generate heat and cause the frost, ice and so on to detach from the sheath, and/or prevent the formation of the latter thereon.

In other words, over the corresponding length of the cable, the sheath 26 is constituted by such a single layer which is capable of generating heat. This layer is made of at least one material which is arranged in a continuous manner radially, and which is integral, which means that it does not define a plurality of strata which are separated from one another.

It should be noted that this does not necessarily mean that the material which makes up the sheath 26 is necessarily the same over the entire thickness 31 of the sheath 26, and/or over the part of the length of the sheath 26 which is considered.

In particular, as discussed below, the sheath 26 may be manufactured so that different materials are made to be integral with one another so that they define the sheath 26 which is then single-layered in the sense of the invention.

As illustrated on the Figures, thus, over at least part of its length, the sheath is formed by the single layer 32, which occupies the entire volume defined between the inner surface 28 and the outer surface 30.

Advantageously, in the context of the invention, the single layer 32 extends over more than 30% of the length of the sheath 26. Preferably, it extends over more than 50% of the length of the sheath.

It should be noted that the sheath may include a plurality of disjoint regions which are distant from one another along the direction of the cable 10 and which together form this single layer 32. For instance, these regions may each correspond to one of the longitudinal segments of the sheath which are assembled together to form the entirety of the latter, although this is not necessarily the case.

In a general embodiment, however, the region of the sheath which is made by the single layer 32 extends continuously along the cable 10.

In a specific embodiment, regardless of the percentage of the length of the cable the layer 32 stretches over or not, the layer 32 stretches only over all or part of the region of the sheath which is located above a predetermined height. This height may be chosen as a minimum altitude of interest, a predetermined distance above the ground and/or a predetermined distance above a component of the structure the cable is coupled to, e.g. the deck of the bridge.

The single layer 32 for instance includes high density polyethylene (known as PEHD or HDPE) as its main component.

It should be noted that this single-layered configuration for the sheath does not exclude the use of a coating 35 (depicted in FIG. 3b) for the sheath 26, for instance in the form of one or more layers coupled to the sheath, typically after the manufacturing of the latter. The coating 35 can then be seen as a component of the cable 10 which is coupled to the sheath 26 in the sense of the invention.

In further view of FIGS. 3a to 5b, so as to generate heat, in the context of the invention, the sheath 26 comprises heating components 34 which are arranged in the layer 32.

Due to their arrangement within the layer 32 which defines the entire thickness of the sheath over the considered portion, in the sense of the invention, the components 34 are embedded within the sheath. This embedded configuration is to be opposed to a coating or surface configuration in general, whereby the heating is obtained using a complex structure which is coupled to the sheath after the latter has been manufactured.

The heating components 34 are configured for receiving electrical energy and convert at least part of this energy into heat so as to heat the outer surface 30 of the sheath 26.

Typically, they are configured to do so by Joule Effect.

As indicated above, this heat is configured to prevent ice, snow, rime or frost from forming thereon and/or remove ice, snow, rime or frost from the outer surface of the sheath 26.

For this purpose, the heating components 34 have a chosen electrical conductivity which is configured to cause the heating at least of the outer surface 30 of the sheath 26.

In effect, each heating component 34 is configured to generate heat locally, this heat propagating within the matter of the layer 32 and reaching the outer surface of the sheath. In practice, although the components 34 may result in a particular region of the sheath being heated, such as a surface layer at the inner surface, heating the outer surface 30 of the sheath 26 is the intended effect.

Advantageously, the heating components 34 are configured so as to obtain a thermal power of at least 0.2 kW/m² at the outer surface 30 of the sheath. Advantageously, the obtained thermal power is equal to or greater than 0.5 kW/m².

In addition, the heating components are configured to prevent any damage to the components of the cable caused by the heat. In particular, they are configured to prevent any melting or burning of the sheath itself.

In a given embodiment, one or more of the following factors may be adjusted to reach the desired thermal power at the outer surface:
The electrical resistivity of the components 34,
The thermal capacity and conductivity of the material of the layer 32;
The density of components 34;
The location of the components relative to the outer surface 30.

Advantageously, the percent by weight of the heating components 34 comprised in the layer 32 is at least 2%. Advantageously, this percent is equal or greater than 5%.

Advantageously, the heating components 34 are located in a portion 36 of the layer 32 which only stretches over part of the thickness 31 of the layer 32.

In other words, the heating components 34 are only present within part of the thickness 31 of the layer 32.

The portion 36 advantageously defines a connected space radially (relative to the axis of the cable). Preferably, it forms a single layer within the layer 32, as opposed to multiple layers which are apart and which need to be considered together.

However, the layer 32 may include a plurality of portions 36 which include components 34. These portions are for instance spread apart radially and optionally cover common longitudinal regions of the cable.

Advantageously, the portion 36 extends along the entirety of the layer 32.

Advantageously, the portion 36 is an external portion of the sheath.

In other words, the portion 36 includes the outer surface 30 of the sheath 26.

In other words, the heating components 34 are concentrated in the outer part of the thickness 31 of the layer 32.

However, as illustrated on FIG. 3c, alternatively, the portion 36 is an intermediary or inner portion relative to the outer surface 30. In other words, it is located at a distance from the outer surface 30 of the sheath 26.

In such a configuration, the radial distance between the outer surface 30 of the sheath 26 and the portion 36 is advantageously inferior to 40%, and preferably to 20% of the thickness of the layer 32. For instance, it is at a distance to the outer surface 30 which is inferior or equal to 2 mm. This distance is for instance measured between the outer surface and the boundary of the portion 36 which is proximal to the latter.

This configuration may be advantageous when the outer surface 30 of the sheath 26 is to exhibit specific properties such as light-protection properties, in particular against UV rays. In effect, this outer surface 30 of the sheath 26 may then be made of a correspondingly-designed material which does not include components 34.

Regardless of the configuration, advantageously, the portion 36 has a thickness 37 inferior to 50% of the thickness 31 of the layer 32. Preferably, this thickness 37 is inferior to 30% of the thickness of the layer 32.

In an alternative general configuration, however, the heating components 34 may be present in the entire thickness 31 of the layer 32 of the sheath 26.

Advantageously, within the space the heating components 34 are present in (e.g. the portion 36 above if they are present only over part of the thickness of the layer 32, otherwise the layer 32 itself at least locally), the heating components 34 are evenly distributed. In other words, the heating components 34 are spatially distributed so as to prevent hot spots having a significantly higher temperature than other regions within the sheath 26, and/or cold spots having a significantly lower temperature than other regions within the sheath 26.

Regarding the heating components 34 themselves, in a first general configuration illustrated on FIGS. 3a, 3b and 3c, the heating components 34 are in the form of dispersed particles. In other words, the heating components 34 are in the form of punctual objects which are dispersed in the volume of the layer 32 (or the portion 36). Preferably, they have a characteristic transverse dimension inferior to 10⁻⁵ m. This characteristic transverse dimension for instance corresponds to a diameter or a maximal diameter.

The heating components 34 may have a characteristic transverse dimension inferior to that, such as one close to 10⁻⁹ m.

For example, the heating components 34 are nanoparticles.

In a given embodiment, the heating components 34 are silver nanoparticles. In another embodiment, the heating components 34 are carbon nanoparticles. In another embodiment, the heating components include both silver and carbon nanoparticles.

In a second general configuration, the components 34 are not in the form of dispersed particles. In such a scenario, they define at least one structure which is arranged within the thickness 31 of the layer 32 and which is configured to generate the heat referred to above.

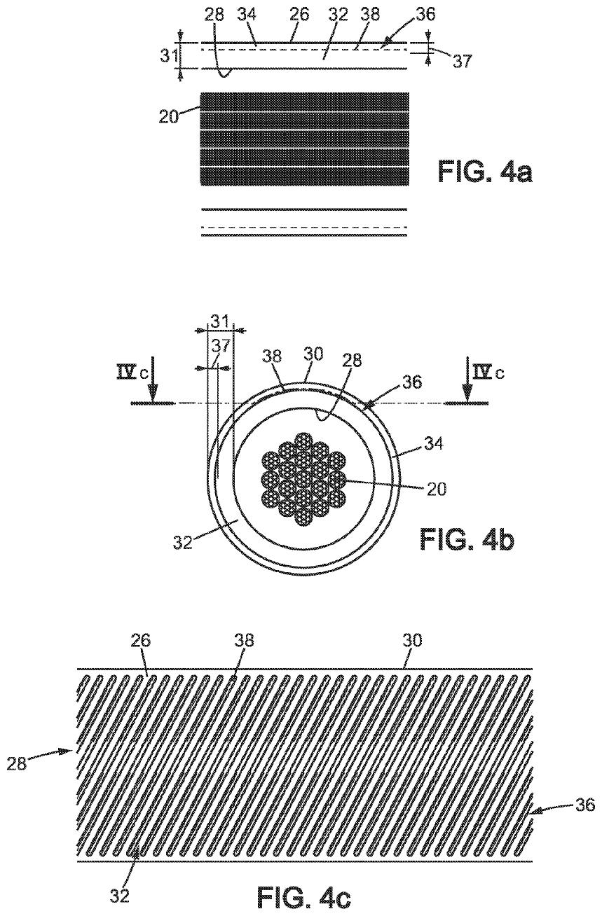

For example, in the embodiment of FIGS. 4a, 4b and 4c, within the space the heating components 34 are present in (e.g. the portion 36 above), the heating components 34 form at least one electrical wire 38.

For instance, the electrical wire(s) 38 has a solenoid arrangement. In other words, the electrical wire 38 is helically arranged along the longitudinal direction of the cable within the thickness of the sheath.

For instance, the wires 38 are then arranged regularly along this direction so as to prevent hot spots and/or cold spots as discussed above.

Advantageously, the wire 38 includes an alloy of Nickel and Chrome and/or Nickel and Copper. These alloys allow for a refined control of the heat thereby generated.

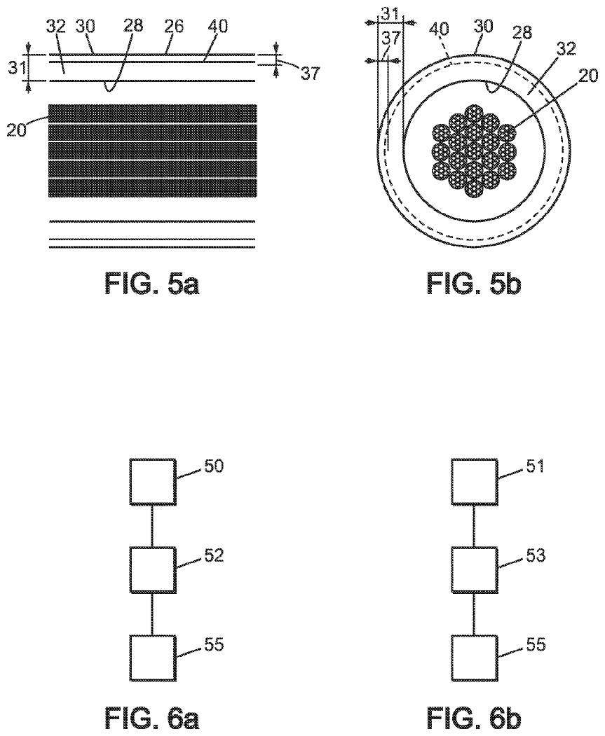

In another embodiment of this second general configuration, in the example illustrated in FIGS. 5a and 5b, the heating components 34 form at least one sheet 40. This sheet 40 is electrically conductive.

Advantageously, as can be seen in FIG. 5b, the sheet 40 is an openwork sheet. The surface of the sheet 40 thus comprises openings, i.e. regions which are not covered by the material of the sheet itself. These openings define together the open surface of the sheet.

Due to the sheet being openwork, the presence of the sheet 40 does not alter the continuity of matter within the single layer 32.

The sheet 40 includes a matrix, which forms the main component of the sheet, as well as the components 34 per se which are loaded in the matrix.

Advantageously, the matrix is made of PEHD.

According to another embodiment, the matrix may be made of a plastic material more flexible than PEHD.

According to yet another embodiment, the matrix may be made of a composite material. In this case, it may include carbon fibers.

As for the components 34 of the sheet, they are advantageously of the particle type and are thus dispersed in the matrix. They may be silver or carbon particles, such as nanoparticles.

Regardless of the specific materials which are considered, the ratio between the open surface of the sheet 40 and the total surface of the sheet is known as the porosity rate. Advantageously, the porosity rate of the sheet is at least 50%. This configuration helps prevent delamination phenomena within the sheath 26.

The electrical energy based on which the heating components 34 operate is provided by the source of energy 11. This source of energy 11 is configured to cause the electrical energy to flow through the heating components 34 and cause the above generation of heat, typically by Joule effect.

The source of energy 11 may take the form of a battery. Alternatively, and preferably, this source of energy 11 includes a connection to an electrical grid via which electrical energy is supplied. For instance, this connection includes a transformer adapted to shape the electrical energy provided by the grid into a format adapted for the heating needs of the cable 10 using the components 34.

For instance, the source of energy 11 may be located near an extremity of the cable 10.

It should be noted that the cable 10 may include a plurality of such sources 11, which can be seen as various components of an energy supply apparatus of the cable 10.

The source of energy 11 may be coupled to electrical paths which stretch along the longitudinal direction of the cable, which include one or more electrical conductors, which are configured to supply the components 34 with the electrical energy provided by the source(s) of energy 11. For example, the electrical paths include electrodes 39 which are inserted in the matter of the sheath 26, as illustrated in FIGS. 3a and 3b and which are supplied electrical energy thereafter supplied to the components 34. For instance, they are electrically coupled to the source by the electrical conductors which are then in the form of electrical wires.

Advantageously, the electrical paths are separated from the tendons by at least one wall. The wall is in particular configured to protect the electrical paths from any damage that may otherwise occur during the insertion of the tendons of the bundle within the sheath 26. Advantageously, this wall also acts as a thermal barrier. Optionally, a further thermal barrier may be added between the wall and the sheath.

Advantageously, when the heating components 34 are arranged as one or more wire 38, the electrical paths may not include electrodes 39. Indeed, in that case, the electrical paths include by the wire(s) 38 itself. In other words, the wire 38 is directly supplied with the electrical energy by the source(s) 11.

A method of manufacturing the sheath 26 will now be described in reference to the Figures, in particular to FIGS. 6a and 6b.

In a general sense, the method comprises forming the sheath 26 from its material.

During this formation, the heating components 34 are arranged within this material, where they can be later used to heat at least the outer surface 30 of the sheath 26 so as to prevent ice, snow, rime or frost from forming thereon or remove ice, snow, rime or frost from the outer surface 30 of the sheath 26.

In effect, to that end, the heating components 34 are introduced into the material or a precursor of the latter.

In more details, during the manufacturing, the material is at least shaped, and optionally transformed as well from a precursor, for instance through a polymerization process.

In reference to FIG. 6a, which is particularly adapted for configurations in which the heating components 34 are particles dispersed directly in the matter of the layer 32 as in FIGS. 3a, 3b and 3c, in a step 50, the heating components 34 are mixed with material which is destined to be shaped into the sheath 26 or the corresponding segment thereof. This material may take the form of beads. In effect, the heating components may be mixed with this material which is then in the form of beads. Alternatively, this mixing may occur prior to the beads being formed, the components 34 being present in the beads themselves.

Then, in a following step 52, the material and the resistive components 34 are extruded. In effect, they are heated and given the desired shape using an adapted piece of equipment, which is for instance known per se. The sheath 26, and advantageously, the various longitudinal segments thereof, is then formed.

This process is carried out for each longitudinal segment of the sheath if they are initially separate. Alternatively, this is done for the entire length of the sheath if it is formed to be integral right from the start.

In an optional step 55, which occurs if the sheath is not produced as an integral member in the previous step, the longitudinal segments of the sheath are assembled together to form the sheath 26.

In reference to FIG. 6b, an alternative configuration is particularly adapted when the heating components 34 are located in a strict portion 36 of the layer 32 (i.e. they are not dispersed in the entirety of the layer 32).

In a first embodiment of this configuration, in a step 51, a first part of the layer 32 which does not comprise the portion 36 is first formed, for instance by extrusion. For instance, a first internal cylindrical portion of the layer 32 which is not to include the components 34 is made.

In a step 53, the portion 36 is then coupled to the part so-obtained.

In a first way of proceeding, to that end, the portion (or portions) 36 is formed directly onto this part of the layer obtained in step 51. For instance, it is then formed by extrusion. Due to the heat of the portion 36, its material fuses together with that of the part obtained beforehand. In some embodiments, a dedicated heating of this part may be carried out, for instance if its temperature is below a certain predetermined value.

In a second way of proceeding, the portion 36 is initially made then placed onto the part obtained in step 51.

The portion 36 may be made by extrusion, for instance along the process described in reference to FIG. 6a. However, any other known process may be used.

It should be noted that the core material of the portion 36 may be different from that of all or part of the rest of the layer 32. For instance, any plastic material may be used, such as a plastic material more flexible than PEHD.

Once the portion 36 has been placed onto the part obtained beforehand, the assembly obtained may optionally be heated so as to cause the portion 36 to fuse with to the part made beforehand at least in part. Advantageously, it is then made integral entirely with this part if the assembly is to form the entirety of the considered longitudinal segment of the sheath (or the entire sheath), i.e. if the assembly defines the entire thickness of the corresponding segment/of the sheath.

Regardless of the way of proceeding which is employed, if the assembly does not define the entirety of the considered segment of the sheath or of the entire sheath, the remaining part of the segment (or sheath) is then coupled to the assembly so that its material is made integral therewith.

For instance, this is done by extrusion, whereby this remaining matter is extruded directly onto the assembly.

In optional step 55, if the steps above were carried out for each longitudinal segment, the segments are assembled together to form the sheath.

In a second embodiment of this configuration, the portion 36 is made simultaneously with the rest of the layer 32, whereby their respective materials of these parts fuse together directly. For instance, this is done by co-extrusion, whereby the different parts of the layer are extruded simultaneously in a superposed manner.

The extrusion of the portion 36 itself typically includes the process of mixing the base material of the layer 32 with the components 34, as detailed in reference to FIG. 6a.

In another embodiment of the manufacturing of the sheath, for components 34 of the second general configuration, a first thickness of the sheath is made, for instance by extrusion, the structure (wire(s)s or sheet(s)) defined by the heating components 34 is arranged thereon, e.g. the sheet 40 or one or more wires 38, and the rest of the thickness of the layer 32 is then made on top thereof, for instance by extrusion (possibly co-extrusion if different materials are to be present in this remaining thickness).

The structure in question itself is for instance made beforehand. For instance, for a sheet 40, the matrix is loaded with the components. As for wires, they are made by any known process, then wound around the first thickness of the sheath.

It should be noted that these embodiments may be hybridized. For instance, a subassembly formed by the portion 36 and a first radial portion of the sheath may be formed in a given manner, this subassembly then being coupled to the remaining part of the sheath (or segment thereof), for instance by co-extrusion.

The invention presents several advantages.

It does not require the use of a costly mechanic-based device which furthermore tends to scratch the outer surface of the sheath. In addition, it is efficient energy-wise, and cost-efficient as well.

Moreover, as the heating components are themselves protected from the environment as they are within the matter of the sheath, the technical solution remains viable over prolonged periods of time without any heavy maintenance.

Further embodiments of the invention are envisaged.

In particular, in the description above, the various types of heating components 34 have been depicted as somewhat exclusive embodiments. In an obvious manner, they can however be combined.

For instance, the sheath may include particle-type components 34 dispersed in the matter of the sheath, as well as one or more sheet and/or electrical wire.

The manufacturing process of the sheath may then be formed by hybridizing the corresponding embodiments above.

Regarding the embodiments of the manufacturing process, they can be combined. For instance, a given process is implemented for some longitudinal segments of the sheath, another process is implemented for some other segments, and so on.

1-14. (canceled)

15. A sheath for a structural cable of a construction work, the structural cable comprising a bundle of tendons to bear a load of the structural cable, the sheath comprising:
an inner surface for facing the bundle of tendons;
an outer surface to be exposed to an environment of the structural cable; and
a single layer of high-density polyethylene (HDPE)-based material having a thickness extending from the inner surface to the outer surface over at least part of the length of the sheath,
wherein heating components are embedded within a portion of the single layer having a thickness smaller than 30% of a thickness of the single layer,
wherein the heating components are configured for receiving electrical energy and, using the electrical energy, heating at least the outer surface of the sheath so as to prevent ice, snow, rime or frost from forming thereon or remove ice, snow, rime or frost from the outer surface of the sheath.

16. The sheath of claim 15, wherein the portion of the single layer where the heating components are located includes the outer surface of the sheath.

17. The sheath of claim 15, wherein the portion of the single layer where the heating components are located is at a distance from the outer surface of the sheath.

18. The sheath of claim 17, wherein the portion of the single layer where the heating components are located is at a distance from the outer surface of at most 20% of the thickness of the single layer.

19. The sheath of claim 15, wherein the heating components include silver or carbon nanoparticles.

20. The sheath of claim 15, wherein the heating components include one or more electrical wires.

21. The sheath of claim 15, wherein the heating components are arranged so as to define at least one heating sheet within the sheath.

22. The sheath of claim 21, wherein the sheet is an openwork sheet.

23. The sheath of claim 22, wherein the of the openwork sheet has a ratio of at least 50% between an open surface of the sheet and a total surface of the sheet.

24. A structural cable comprising:
a bundle of tendons which bear a load of said structural cable, and
a sheath receiving the bundle of tendons therein, wherein the sheath comprises:
an inner surface for facing the bundle of tendons;
an outer surface to be exposed to an environment of the structural cable; and
a single layer of high-density polyethylene (HDPE)-based material having a thickness extending from the inner surface to the outer surface over at least part of the length of the sheath,
wherein heating components are embedded within a portion of the single layer having a thickness smaller than 30% of a thickness of the single layer,
wherein the heating components are configured for receiving electrical energy and, using the electrical energy, heating at least the outer surface of the sheath so as to prevent ice, snow, rime or frost from forming thereon or remove ice, snow, rime or frost from the outer surface of the sheath.

25. A construction work comprising:
at least one structural cable; and
a source of energy,
wherein the structural cable comprises:
a bundle of tendons which bear a load of said structural cable, and
a sheath receiving the bundle of tendons therein, wherein the sheath comprises:
an inner surface for facing the bundle of tendons;
an outer surface to be exposed to an environment of the structural cable; and
a single layer of high-density polyethylene (HDPE)-based material having a thickness extending from the inner surface to the outer surface over at least part of the length of the sheath,
wherein heating components are embedded within a portion of the single layer having a thickness smaller than 30% of a thickness of the single layer,
wherein the heating components are configured for receiving electrical energy and, using the electrical energy, heating at least the outer surface of the sheath so as to prevent ice, snow, rime or frost from forming thereon or remove ice, snow, rime or frost from the outer surface of the sheath,
and wherein the source of energy is configured to provide the heating components with electrical energy to heat at least the outer surface of the sheath.
